(19) United States
(12) Patent Application Publication
(10) Pub. No.: US 2023/0302648 A1
(43) Pub. Date: Sep. 28, 2023

(54) CONTROL DEVICE, CONTROL SYSTEM, PROGRAM, AND CONTROL METHOD

(71) Applicant: FANUC CORPORATION, Yamanashi (JP)

(72) Inventor: Shinichi MIZUKAMI, Yamanashi (JP)

(73) Assignee: FANUC CORPORATION, Yamanashi (JP)

(21) Appl. No.: 18/248,216

(22) PCT Filed: Oct. 18, 2021
(86) PCT No.: PCT/JP2021/038459

§ 371 Date: Apr. 6, 2023

(30) Foreign Application Priority Data
Oct. 21, 2020 (JP) 2020-176448

(51) Int. Cl. B25J 9/16

(52) U.S. Cl. CPC B25J 9/1676

(57) ABSTRACT

One aspect of the present invention comprises a movement control unit. The movement control unit, upon detection of an outage of electrical power supplied from a main power supply to a robot, controls a movement device for moving the robot to move the robot by driving with electrical power supplied from a backup power supply. The movement control unit preferably determines a movement method for allowing the robot that may come into contact with an object to move so as not to come into contact with the object, and controls the movement device to move the robot with the movement method.

### TECHNICAL FIELD

The present invention relates to a control device, a control system, a program, and a control method.

### BACKGROUND ART

Robots such as robot arms may be used near a moving object such as a slide of a press machine. Normally, robots are controlled not to come into contact with such an object unintentionally.

Patent Document 1: Japanese Unexamined Patent Application, Publication No. 2015-155134

### DISCLOSURE OF THE INVENTION

### Problems to Be Solved by the Invention

However, when action stops due to a power outage or the like, the robot may unintentionally come into contact with such an object. Furthermore, a large force may be applied thereby, which may cause a breakdown or damage in the robot or the object.

An object of an embodiment of the present invention is to provide a control device, a control system, a program, and a control method capable of preventing unintentional contact between a moving object and a robot in the event of a power outage.

### Means for Solving the Problems

One aspect of the present invention includes a movement control unit. Upon detecting an outage of electrical power supplied from a main power supply to a robot, the movement control unit moves the robot by performing control of a movement device that drives and moves the robot by electrical power supplied from a backup power supply.

### Effects of the Invention

According to one aspect, it is possible to prevent unintentional contact between the moving object and the robot in the event of a power outage.

### BRIEF DESCRIPTION OF THE DRAWINGS

FIG. 1 is a diagram showing an example of a robot control system according to an embodiment and an example of a main configuration of structural elements included in the robot control system;

FIG. 2 is a flowchart showing an example of processing performed by a processor in FIG. 1;

FIG. 3 is a diagram for describing retraction of a robot in FIG. 1;

FIG. 4 is a diagram for describing retraction of the robot in FIG. 1;

FIG. 5 is a diagram showing an example of a robot control system according to a first modification example and an example of a main configuration of structural elements included in the robot control system; and

FIG. 6 is a diagram showing an example of a robot control system according to a second modification example and an example of a main configuration of structural elements included in the robot control system.

### PREFERRED MODE FOR CARRYING OUT THE INVENTION

Hereinafter, a robot control system according to an embodiment of the present invention will be described with reference to the accompanying drawings. Note that the scale of each unit may be changed in each of the drawings used for describing the embodiment hereinafter. Furthermore, in each of the drawings used for describing the embodiment hereinafter, some structures may be omitted for the sake of explanation. Moreover, in each of the drawings and the description, same reference signs indicate similar elements.

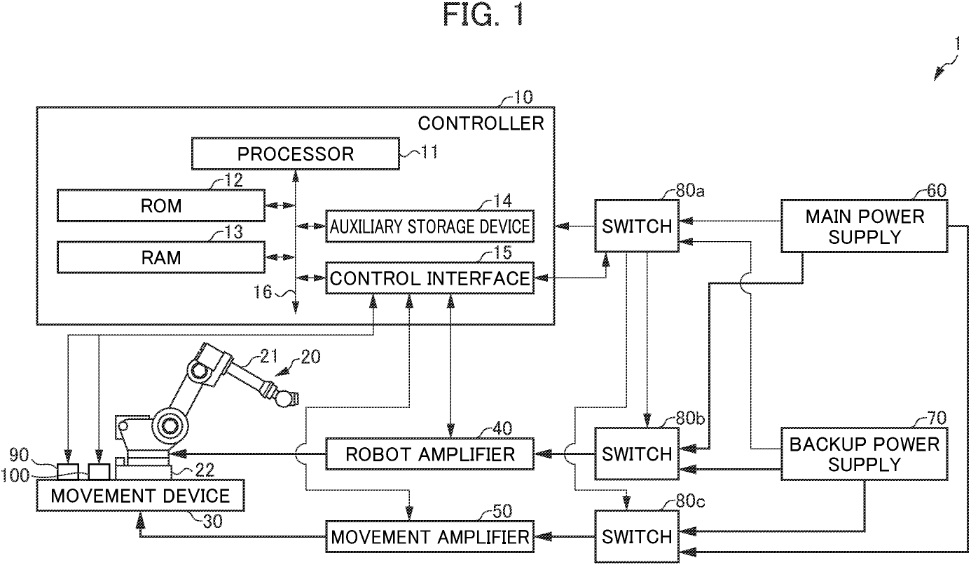

FIG. 1 is a diagram showing an example of a robot control system 1 according to the embodiment and an example of a main configuration of structural elements included in the robot control system 1. As an example, the robot control system 1 includes a controller 10, a robot 20, a movement device 30, a robot amplifier 40, a movement amplifier 50, a main power supply 60, a backup power supply 70, a switch 80, a human sensor 90, and a light 100. While FIG. 1 shows one each of the controller 10, the robot 20, the movement device 30, the robot amplifier 40, the movement amplifier 50, the main power supply 60, and the backup power supply 70, there may also be a plurality of those units. Note that the robot control system 1 is an example of a control system. A thick line in FIG. 1 indicates high power that is the electrical power of 50 volts or more as an example, and a thin line indicates low power that is the electrical power of less than 50 volts as an example.

The controller 10 controls the robot amplifier 40 and the movement amplifier 50. The controller 10 includes, as an example, a processor 11, a ROM (read-only memory) 12, a RAM (random-access memory) 13, an auxiliary storage device 14, and a control interface 15. Furthermore, a bus 16 and the like connect each of those units. Note that the controller 10 is an example of a control device.

The processor 11 corresponds to the brain of a computer that executes processing such as arithmetic operations, control, and the like required for operations of the controller 10. The processor 11 controls each unit for achieving various functions of the controller 10 based on programs such as firmware, system software, and application software stored in the ROM 12, the auxiliary storage device 14, or the like. Furthermore, the processor 11 executes processing to be described later based on the programs. Note that a part of or the whole programs may be installed within a circuit of the processor 11. The processor 11 may be a CPU (central processing unit), an MPU (micro processing unit), a SoC (system on a chip), a DSP (digital signal processor), a GPU (graphics processing unit), an ASIC (application specific integrated circuit), a PLD (programmable logic device) or an FPGA (field-programmable gate array), or the like, for example. Alternatively, the processor 11 is a combination of a plurality of those.

The ROM 12 corresponds to a main storage device of a computer having the processor 11 as the brain. The ROM 12 is a nonvolatile memory used exclusively for reading data. Among the programs described above, the ROM 12 stores firmware and the like, for example. The ROM 12 also stores data and the like used when the processor 11 executes various kinds of processing.

The RAM 13 corresponds to a main storage device of the computer having the processor 11 as the brain. The RAM 13 is a memory used for reading and writing data. The RAM 13 is used as a work area or the like for temporarily storing data to be used when the processor 11 executes various kinds of processing. The RAM 13 is typically a volatile memory.

The auxiliary storage device 14 corresponds to an auxiliary storage device of the computer having the processor 11 as the brain. The auxiliary storage device 14 may be an EEPROM (electric erasable programmable read-only memory), an HDD (hard disk drive), a flash memory, or the like, for example. Among the programs described above, the auxiliary storage device 14 stores system software, application software, and the like, for example. Furthermore, the auxiliary storage device 14 stores data used when the processor 11 executes various kinds of processing, data generated by the processing executed by the processor 11, various kinds of setting values, and the like.

The control interface 15 is an interface for allowing the controller 10 to connect and communicate with the robot amplifier 40, the movement amplifier 50, the switch 80, the human sensor 90, the light 100, and the like. The controller 10 controls the robot amplifier 40, the movement amplifier 50, the switch 80, the human sensor 90, the light 100, and the like via the control interface 15.

The bus 16 includes a control bus, an address bus, a data bus, and the like, and transmits signals exchanged among each of the units of the controller 10.

The robot 20 is a robot arm having a plurality of drive axes, for example. The robot 20 has six drive axes, as an example. The robot 20 includes an arm part 21 and a fixation part 22. The arm part 21 is a part that is driven by the drive axes. The drive axes are driven by a motor or the like. The fixation part 22 fixes the robot 20 to the movement device 30.

The movement device 30 moves the robot 20 in a translational motion. Alternatively, the movement device 30 moves the robot 20 in a rotational motion. Alternatively, the movement device 30 moves the robot 20 by a combination of translational motion and rotational motion. The movement device 30 moves the robot 20 by a single drive axis, as an example.

The robot amplifier 40 outputs the electrical power supplied from the main power supply 60 or the backup power supply 70 to motors of each of the drive axes of the robot 20 as necessary, based on the control of the controller 10. Therefore, the controller 10 controls the robot 20 via the robot amplifier 40. When the robot 20 has six axes, the robot amplifier 40 is a 6-axis amplifier, as an example.

The movement amplifier 50 outputs the electrical power supplied from the main power supply 60 or the backup power supply 70 to the movement device 30 as necessary, based on the control of the controller 10. Therefore, the controller 10 controls the movement device 30 via the movement amplifier 50. When the movement device 30 has single axis, the movement amplifier 50 is a 1-axis amplifier, as an example.

The main power supply 60 supplies the electrical power to each of the units of the robot control system 1. The main power supply 60 supplies low power to the controller 10 via a switch 80a. The main power supply 60 supplies high power to the robot amplifier 40 via a switch 80b. The main power supply 60 supplies high power to the movement amplifier 50 via a switch 80c.

The backup power supply 70 supplies the electrical power to each of the units of the robot control system 1, when the main power supply 60 becomes unable to supply the electrical power due to a power outage or the like. The backup power supply 70 supplies the electrical power from a power supply different from the main power supply 60, such as a battery or a power generator, for example. The backup power supply 70 supplies low power to the controller 10 via the switch 80a. The backup power supply 70 supplies high power to the robot amplifier 40 via the switch 80b. The backup power supply 70 supplies high power to the movement amplifier 50 via the switch 80c.

The switch 80 is the switch for selecting and switching the source of the electrical power from the main power supply 60 and the backup power supply 70. The robot control system 1 includes the three switches 80 that are the switch 80a, the switch 80b, and the switch 80c, as an example. The switch 80a is the switch for selecting and switching the source of the electrical power supplied to the controller 10 from the main power supply 60 and the backup power supply 70. Note that the controller 10 may have the switch 80a built therein. The switch 80b is the switch for selecting and switching the source of the electrical power supplied to the robot amplifier 40 from the main power supply 60 and the backup power supply 70. The switch 80c is the switch for selecting and switching the source of the electrical power supplied to the movement amplifier 50 from the main power supply 60 and the backup power supply 70.

As for the switch 80b and the switch 80c, the source of the electrical power is switched in conjunction with the switch 80a switching the source of the electrical power. That is, when the controller 10 switches the switch 80a, the switch 80b and the switch 80c are also switched. Thus, when the switch 80a is supplying the electrical power supplied from the main power supply 60 to the controller 10, the switch 80b and the switch 80c are also supplying the electrical power supplied from the main power supply 60 to the robot amplifier 40 and the movement amplifier 50. Furthermore, when the switch 80a is supplying the electrical power supplied from the backup power supply 70 to the controller 10, the switch 80b and the switch 80c are also supplying the electrical power supplied from the backup power supply 70 to the robot amplifier 40 and the movement amplifier 50. Note, however, that the switch 80b and the switch 80c may not be in conjunction with the switch 80a, and the source of the electrical power thereof may be switched independently.

The human sensor 90 is a sensor for detecting presence of a person or the like near the robot 20. The human sensor 90 is installed on the robot 20 or the movement device 30, for example. The human sensor 90 detects whether there is a person or the like within a detection range, for example. The human sensor 90 also detects the position of the person within the detection range. Furthermore, the human sensor 90 outputs detection information indicating a detection result. The light 100 is a light source such as an incandescent lamp, a fluorescent lamp, an LED (light-emitting diode), or the like. The light 100 is installed on the robot 20 or the movement device 30, for example.

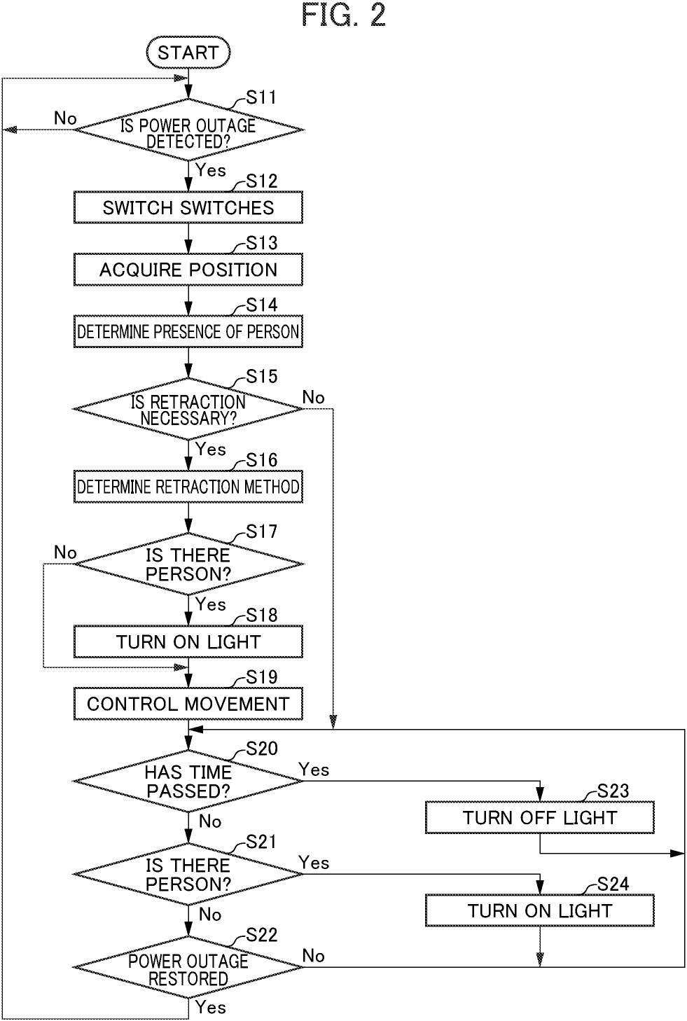

Hereinafter, operations of the robot control system 1 according to the embodiment will be described by referring to FIG. 2 and the like. Note that the content of processing in the following explanations of the operations is only an example, and various kinds of processing capable of acquiring similar effects can be used as appropriate. FIG. 2 is a flowchart showing an example of the processing executed by the processor 11 of the controller 10. The processor 11 executes the processing of FIG. 2 based on a program stored in the ROM 12, the auxiliary storage device 14, or the like, for example.

In Step S11 of FIG. 2, the processor 11 of the controller 10 determines whether it has been detected that the main power supply 60 will have a power outage or the main power supply 60 is having a power outage. The controller 10 can detect a power outage by using a known method. Note that the main power supply 60 comes to have a power outage when the power supplied to the main power supply 60 stops, for example. Alternatively, the main power supply 60 faces a power outage by a breakdown of the main power supply 60 or a mis-operation or the like made on the main power supply 60. When a power outage of the main power supply 60 is not detected, the processor 11 determines as No in Step S11 and repeats the processing of Step S11. Then, when a power outage of the main power supply 60 is detected, the processor 11 determines as Yes in Step S11 and advances to Step S12. Therefore, the controller 10 functions as a detection unit that detects a power outage. Furthermore, the processor 11 detects a power outage by executing the processing of Step S11.

In Step S12, the processor 11 switches the switch 80 to change the source of electrical power from the main power supply 60 to the backup power supply 70.

In Step S13, the processor 11 acquires information indicating the position and posture of the robot 20 from, for example, the robot 20, the robot amplifier 40, or the like. Note that the information indicating the position of the robot 20 is a coordinate indicating the position on a space, for example. Furthermore, the information indicating the posture of the robot 20 includes a rotation angle or the like of each drive axis of the robot 20 with respect to a reference position, for example. In Step S14, the processor 11 acquires detection information from the human sensor 90.

In Step S15, the processor 11 determines whether it is necessary to retract the robot 20 based on the position and the posture of the robot 20. The processor 11 determines that it is necessary to retract the robot 20, when at least a part of the robot 20 is within a prescribed range, for example. Note that the processor 11 determines whether at least a part of the robot 20 is within the prescribed range, based on the position and the posture of the robot 20 acquired in Step S13, for example.

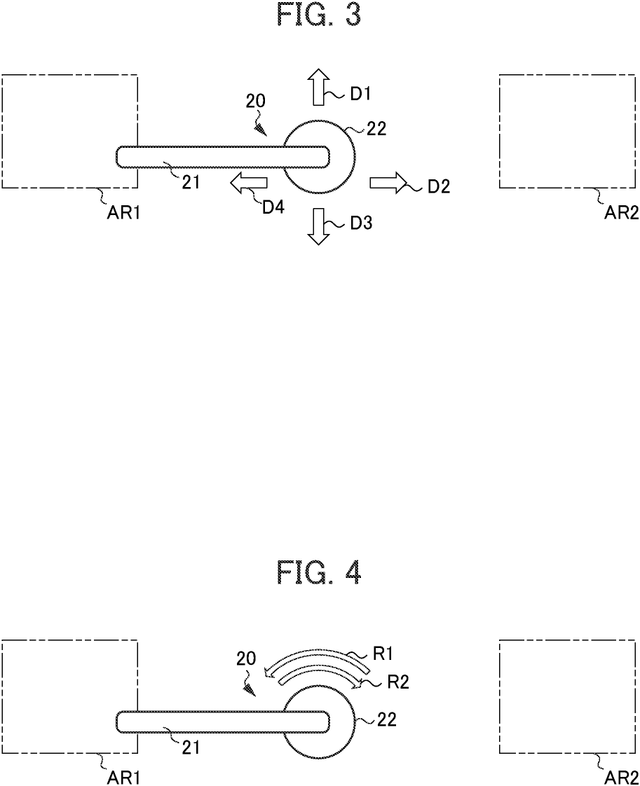

FIG. 3 is a diagram for describing retraction of the robot 20. In FIG. 3, a range AR1 and a range AR2 indicate ranges where a moving object such as a slide of a press machine passes, which are examples of the prescribed range. Note that the range AR1 and the range AR2 are collectively referred to as a range AR. When a part of the robot arm such as the arm part 21 is within the range AR, there is a possibility of making a contact with the slide or the like of the press machine. In FIG. 3, the arm part 21 is within the range AR1, as an example. In that case, the processor 11 determines that it is necessary to retract the robot 20. Note that there is no limit set for the number and shape of the range AR. Furthermore, the range AR may be a two-dimensional shape or a three-dimensional shape.

Moreover, the range AR may also be a range where a person may enter. Note that a person is an example of a moving object. For example, the processor 11 specifies the position where a person is at from the detection information acquired in Step S14. Then, the processor 11 determines a range within a specific distance from the person indicated in the detection information as the range AR, for example. Alternatively, the processor 11 determines a range within a specific distance in a traveling direction of the person as the range AR, for example. Note that the processor 11 may exclude, from the range AR, a range where a person cannot enter because a machine or the like is installed.

Other examples of the moving object may be a vehicle, luggage on a conveyor, and robots other than the robot 20.

When it is determined that it is necessary to retract the robot 20, the processor 11 determines as Yes in Step S15 and advances to step S16.

In Step S16, the processor 11 determines a movement method for retracting the robot 20 based on the position and the posture of the robot 20. That is, the processor 11 determines the moving direction and the moving distance of the robot 20 as the movement method, for example. In FIG. 3, four moving directions from direction D1 to direction D4 are indicated as examples. The processor 11 determines, from the direction D1 to the direction D4, the moving direction with which the arm part 21 can move out from the range AR1 with a short moving distance, based on the position of the robot 20 acquired in Step S13. Furthermore, the processor 11 determines the moving distance required for the arm part 21 to move out from the range AR1. Note that the moving directions indicated in FIG. 3 are examples, and the movable directions of the robot 20 are not limited to the direction D1 to the direction D4. Furthermore, the number of directions the robot 20 can move is not limited to four directions.

The movement method shown in FIG. 3 is to retract the robot 20 in a translational motion. The method for retracting the robot 20 in a rotational motion will be described by referring to FIG. 4. FIG. 4 is a diagram for describing retraction of the robot 20. In FIG. 4, two moving directions that are a rotation direction R1 and a rotation direction R2 are indicated as examples. The processor 11 determines, from the rotation direction R1 and the rotation direction R2, the moving direction with which the arm part 21 can move out from the range AR1 with a short moving distance (rotation angle), based on the position of the robot 20 acquired in Step S13. Furthermore, the processor 11 determines the moving distance required for the arm part 21 to move out from the range AR1. Note that the moving directions indicated in FIG. 4 are examples, and the movable (rotatable) rotation directions of the robot 20 are not limited to the rotation direction R1 and the rotation direction R2. Furthermore, the number of rotation directions the robot 20 can move is not limited to two directions.

In the manner described above, the processor 11 determines the movement method by executing the processing of Step S16.

In Step S17, the processor 11 determines whether there is a person near the robot 20. The processor 11 determines that there is a person near the robot 20, when found that a person is within a detection range based on the detection information acquired in Step S14, for example. When it is determined that a person is near the robot 20, the processor 11 determines as Yes in Step S17 and advances to Step S18.

In Step S18, the processor 11 turns on the light 100. Furthermore, the processor 11 starts count of a timer T that indicates the time from the start of lighting up the light. As described above, the processor 11 functions as a light control unit that turns on the light 100, when an object is detected by the human sensor by executing the processing of Step S14, Step S17, and Step S18.

After the processing of Step S18, the processor 11 advances to Step S19. Furthermore, when it is not determined that person is near the robot 20, the processor 11 determines as No in Step S17 and advances to Step S19.

In Step S19, the processor 11 retracts the robot 20 by the movement method determined in Step S16. That is, the processor 11 operates the movement device 30 by controlling the movement amplifier 50 so as to move the robot 20 to the moving direction determined in Step S16 for the moving distance determined in Step S16. Therefore, the processor 11 functions as a movement control unit that moves the robot 20 by controlling the movement device 30, upon detecting a power outage by executing the processing of Step S11 and Step S19.

After the processing of Step S19, the processor 11 advances to Step S20. Furthermore, when it is determined that retraction of the robot 20 is not necessary, the processor 11 determines as No in Step S15 and advances to Step S20. In Step S20, the processor 11 determines whether the timer T indicates a prescribed time or more. When the timer T indicates less than the prescribed time, the processor 11 determines as No in Step S20 and advances to Step S21.

In Step S21, the processor 11 determines whether there is a person near the robot 20. The processor 11 acquires detection information from the human sensor 90, for example. Then, when the detection information indicates that there is a person within the detection range, the processor 11 determines that there is a person near the robot 20. When it is not determined that person is near the robot 20, the processor 11 determines as No in Step S21 and advances to Step S22.

In Step S22, the processor 11 determines whether the power outage is restored. When it is determined that the power outage is not restored, the processor 11 determines as No in Step S22 and returns to Step S20. Thereby, the processor 11 is in a standby state that repeats Step S20 to Step S22 until determining that the timer T reaches the prescribed time or more, there is a person near the robot 20, or the power outage is restored.

When the timer T indicates the prescribed time or more in the standby state of Step S20 to S22, the processor 11 determines as Yes in Step S20 and advances to Step S23. In Step S23, the processor 11 turns off the light 100.

When it is determined that there is a person near the robot 20 in the standby state of Step S20 to S22, the processor 11 determines as Yes in Step S21 and advances to Step S24. In Step S24, the processor 11 turns on the light 100 when the light 100 is off. Furthermore, the processor 11 resets the timer T to set the count to “0”. In the manner described above, the processor 11 functions as a light control unit that turns on the light 100, when an object is detected by the human sensor by executing the processing of Step S21 and Step S24.

When the power outage is restored in the standby state of Step S20 to Step S22, the processor 11 determines as Yes in Step S22 and returns to Step S11.

Next, the energy supply capacity required for the backup power supply 70 will be described. The backup power supply 70 is required to have the capacity to supply the amount of electrical power (energy) necessary for moving the robot 20 by the movement method determined in Step S16. Therefore, when the backup power supply 70 supplies the electrical power by a battery, the battery needs to have the capacity to store the energy capable of moving the robot 20 to be out of the range AR regardless of where a part of or the whole part of the robot 20 is located within the range AR. Furthermore, when the backup power supply 70 supplies the electrical power by a power generator, the fuel for the power generator needs to be in the amount for generating the energy capable of moving the robot 20 to be out of the range AR regardless of where a part of or the whole part of the robot 20 is located within the range AR.

In order to find such an energy, the processor 11 finds the moving distance, when the position and the posture of the robot 20 are in a state where the moving distance required for moving the robot 20 out of the range AR is the longest. Then, the processor 11 finds the energy required for moving the robot 20 for the moving distance by the movement device 30, using a function, a table, or the like for converting the moving distance into energy. Since the energy indicates the energy supply capacity required for the backup power supply 70, knowing the energy makes it easier to mount, to the robot control system 1, the backup power supply 70 that has necessary capacity but not too high.

Furthermore, when the backup power supply 70 that has an insufficient capacity for supplying the energy is connected to the robot control system 1, the processor 11 may control a display device, an audio output device, or the like to notify that the backup power supply 70 with an insufficient capacity for supplying the energy is connected.

With the robot control system 1 according to the embodiment, when an outage of the electrical power supplied to the robot amplifier 40 by the main power supply 60 is detected, the controller 10 determines the movement method for retracting the robot 20 from the range where there is a possibility of making a contact with a moving object such as a slide of a press machine. Then, the controller 10 controls the movement device 30 to move the robot 20 to retract the robot 20 from the range. In this manner, the controller 10 of the embodiment can prevent the robot 20 from making a contact and colliding with the moving object such as the slide of the press machine even in the event of a power outage.

Furthermore, with the robot control system 1 according to the embodiment, the controller 10 determines the movement method of the robot based on the position of the robot 20. In this manner, the controller 10 of the embodiment can determine the movement method of a smaller power consumption compared to the case not using the position of the robot 20. It is because the shorter the moving distance for retraction, the smaller the power consumption required for retraction.

Furthermore, with the robot control system 1 according to the embodiment, the controller 10 determines the movement method of the robot based on the posture of the robot 20. In this manner, the controller 10 of the embodiment can determine the movement method of a smaller power (energy) consumption compared to the case not using the posture of the robot 20.

Furthermore, with the robot control system 1 according to the embodiment, the controller 10 determines whether retraction is necessary, and determines the movement method when it has been determined to be necessary. In this manner, the controller 10 does not execute unnecessary processing.

Furthermore, with the robot control system 1 according to the embodiment, when there is an object detected by the human sensor 90, the controller 10 determines the movement method so as not to come into contact with the object. In this manner, the controller 10 can prevent the person and the like from coming into contact with the robot 20 under a power outage.

Furthermore, with the robot control system 1 according to the embodiment, when there is an object detected by the human sensor 90, the controller 10 turns on the light. In this manner, the controller 10 can prevent the person and the like from coming into contact with the robot 20 when the lighting in a factory where the robot 20 is installed is off due to a power outage or the like.

In regards to the embodiment described above, modifications as follows are also possible. In the embodiment described above, the controller 10 detects a power outage, and the controller 10 controls switching of the source of electrical power to be supplied. However, in the robot control system according to the embodiment, structural elements other than the controller 10 may detect the power outage as well. Furthermore, in the robot control system according to the embodiment, structural elements other than the controller 10 may control switching of the source of electrical power to be supplied. Hereinafter, a first modification example and a second modification example where a power outage is detected by structural elements other than the controller 10 will be described. The first modification example and the second modification example are modification examples of the embodiment.

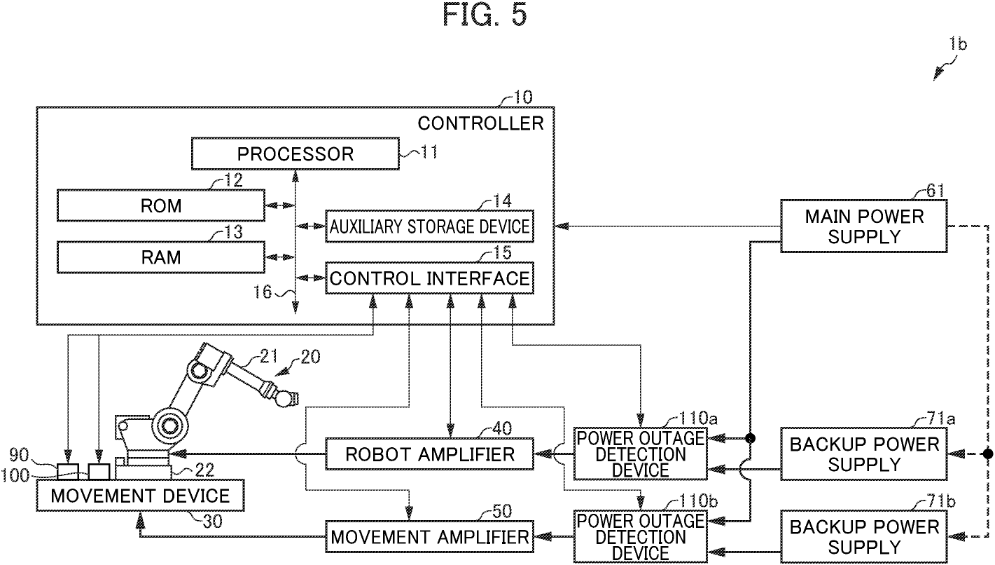

FIG. 5 is a block diagram showing an example of a robot control system 1b according to the first modification example and an example of a main configuration of structural elements included in the robot control system 1b. In the first modification example, the points same as those of the embodiment described above will not be discussed. As an example, the robot control system 1b includes a controller 10, a robot 20, a movement device 30, a robot amplifier 40, a movement amplifier 50, a main power supply 61, a backup power supply 71, a human sensor 90, a light 100, and a power outage detection device 110.

The main power supply 61 is an uninterruptable power supply provided with a battery. The main power supply 61 supplies low power to the controller 10. The main power supply 61 supplies high power to the robot amplifier 40 via a power outage detection device 110a. The main power supply 61 supplies high power to the movement amplifier 50 via a power outage detection device 110b. Furthermore, the main power supply 61 supplies high power to the backup power supply 71 to charge the backup power supply 71. When the electrical power supplied to the main power supply 61 faces a power outage, the main power supply 61 stops supplying high power. When the electrical power supplied to the main power supply 61 faces a power outage, the main power supply 61 continues supplying low power to the controller 10 by using a built-in battery. In this way, the main power supply 61 stops supplying the electrical power to the robot amplifier 40 and the movement amplifier 50 of relatively large power consumption and continues supplying the electrical power to the controller 10 of relatively small power consumption so as to suppress reduction in the remaining charged level of the built-in battery.

The backup power supply 71 is a secondary battery. The robot control system 1b includes two backup power supplies 71 that are a backup power supply 71a and a backup power supply 71b. The backup power supply 71a supplies high power to the robot amplifier 40 via the power outage detection device 110a. The backup power supply 71b supplies high power to the movement amplifier 50 via the power outage detection device 110b.

The power outage detection device 110 is a switch having a function of detecting the power outage of the main power supply 61, for example. Upon detecting the power outage of the main power supply 61, the power outage detection device 110 switches the source of electrical power from the main power supply 61 to the backup power supply 71. Note that the backup power supply 71 may have the power outage detection device 110 built therein. Furthermore, upon detecting the power outage of the main power supply 61, the power outage detection device 110 outputs power outage information indicating that the power outage of the main power supply 61 is detected. The power outage detection device 110 is an example of a detection unit that detects a power outage.

In the first modification example, in Step S11 of FIG. 2, the processor 11 of the controller 10 detects a power outage upon receiving the power outage information from the power outage detection device 110. Furthermore, in the first modification example, the processor 11 skips the processing of Step S12.

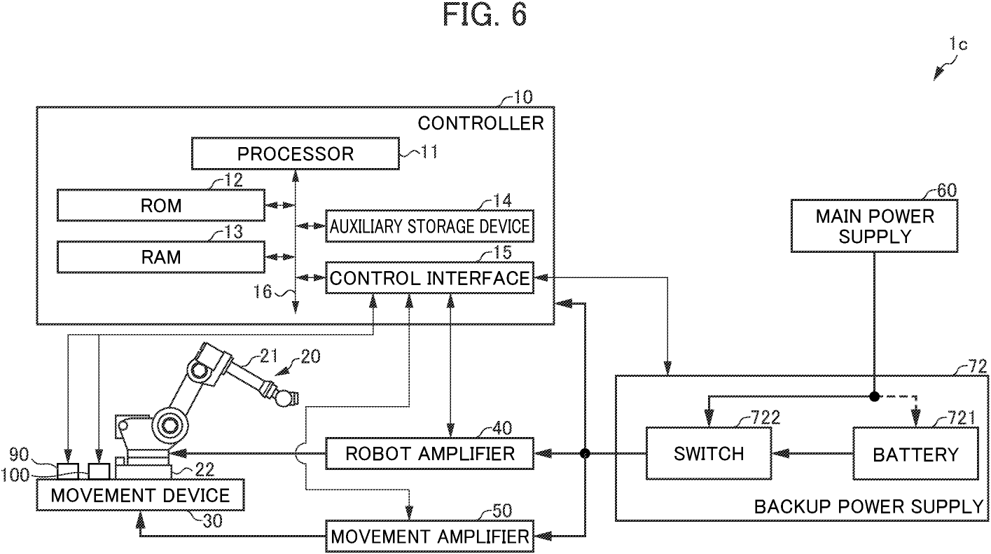

FIG. 6 is a block diagram showing an example of a robot control system 1c according to the second modification example and an example of a main configuration of structural elements included in the robot control system 1c. In the second modification example, the points same as those of the embodiment described above will not be discussed. As an example, the robot control system 1c includes a controller 10, a robot 20, a movement device 30, a robot amplifier 40, a movement amplifier 50, a main power supply 60, a backup power supply 72, a human sensor 90, and a light 100.

The main power supply 60 of the second modification example supplies high power to the backup power supply 72. The backup power supply 72 supplies high power to the controller 10, the robot amplifier 40, and the movement amplifier 50. The backup power supply 72 includes a battery 721 and a power outage detection device 722.

The battery 721 is a secondary battery. The backup power supply 72 charges the battery 721 with the electrical power supplied from the main power supply 60. The power outage detection device 722 is a switch having a function of detecting a power outage of the main power supply 60, for example. The power outage detection device 722 selects and switches the source of electrical power from the main power supply 60 and the battery 721. When the main power supply 60 is supplying the electrical power properly, the power outage detection device 722 supplies the electrical power supplied from the main power supply 60 to the controller 10, the robot amplifier 40 and the movement amplifier 50. Then, upon detecting a power outage of the main power supply 60, the power outage detection device 722 switches the source of electrical power from the main power supply 60 to the battery 721. In this manner, the power outage detection device 722 supplies the electrical power supplied from the battery 721 to the controller 10, the robot amplifier 40, and the movement amplifier 50. Upon detecting the power outage of the main power supply 60, the backup power supply 72 outputs power outage information indicating that the power outage of the main power supply 60 is detected. Therefore, the backup power supply 72 or the power outage detection device 722 is an example of a detection unit that detects a power outage.

In the second modification example, in Step S11 of FIG. 2, the processor 11 of the controller 10 detects a power outage upon receiving the power outage information from the power outage detection device 110. Furthermore, in the second modification example, the processor 11 skips the processing of Step S12.

In the robot control system of the embodiment, the main power supply may detect the power outage.

In the embodiment described above, the processor 11 of the controller 10 determines the movement method of the robot 20 based on the position and the posture of the robot 20. However, the processor 11 may determine the movement method based only on the position of the robot 20. In that case, the processor 11 determines the movement method with which the entire robot 20 comes to be out of the range AR regardless of the posture of the robot 20. Note that the auxiliary storage device 14 or the like may store a table or the like in which a movement method defined in advance is linked to (associated with) each position range of the robot 20. In that case, the processor 11 specifies which range the position of the robot 20 is in. Then, the processor 11 refers to the table, and determines a movement method from the specified position range.

Furthermore, the processor 11 may also determine the movement method based only on the posture of the robot 20. In that case, the processor 11 determines the movement method with which the entire robot 20 comes to be out of the range AR regardless of the position of the robot 20. Note that the auxiliary storage device 14 or the like may store a table or the like in which a movement method defined in advance is linked to (associated with) each posture range of the robot 20. In that case, the processor 11 specifies which range the posture of the robot 20 is in. Then, the processor 11 refers to the table, and determines a movement method from the specified posture range.

Furthermore, the auxiliary storage device 14 or the like may store a table or the like in which a movement method defined in advance is linked to (associated with) each position and posture range of the robot 20. In that case, the processor 11 specifies which range the posture and the position of the robot 20 are in. Then, the processor 11 refers to the table, and determines a movement method from the specified position and posture range.

The processor 11 may turn on the light, when a person is near the robot 20 and the surroundings of the robot 20 are darker than a prescribed level. In that case, the robot control system according to the embodiment includes a sensor that measures the brightness of the surroundings of the robot 20.

The controller 10 may also retract the robot 20 by a movement method defined in advance, regardless of the position and the posture of the robot 20. In that case, when it is determined as Yes in Step S11, for example, the processor 11 of the controller 10 advances to Step S17. Then, the processor 11 controls the movement amplifier 50 to retract the robot 20 in Step S19 by the movement method defined in advance.

The robot 20 may have the movement device 30 built therein. It is also possible to employ a mode in which the backup power supply 70 does not supply the electrical power to the robot 20 and the robot amplifier 40.

The processor 11 may achieve a part of or the whole part of the processing that is implemented by the program in the embodiment with a hardware configuration of a circuit.

The program implementing the processing of the embodiment is provided by being stored in a device, for example. However, the device may also be provided without storing the program. Furthermore, the program may be provided separately, and written into the device. In that case, the program may be provided by being recorded on a removable storage medium or may be downloaded via a network such as the Internet or LAN (local area network), for example.

While the embodiment of the present invention is described above, it is presented as example only, and the scope of the present invention is not limited thereto. The embodiment of the present invention can be implemented in various modes without departing from the scope of the present invention.

### EXPLANATION OF REFERENCE NUMERALS

1 Robot control system
10 Controller
11 Processor
12 ROM
13 RAM
14 Auxiliary storage device
15 Control interface
16 Bus
20 Robot
21 Arm part
22 Fixation part
30 Movement device
40 Robot amplifier
50 Movement amplifier
60 Main power supply
70, 71a, 71b, 72 Backup power supply
80a, 80b, 80c Switch
90 Human sensor
100 Light
110a, 110b, 722 Power outage detection device
721 Battery

1. A control device, comprising:
a movement control unit that, upon detecting an outage of electrical power supplied from a main power supply to a robot, moves the robot by performing control of a movement device that drives and moves the robot by electrical power supplied from a backup power supply.

2. The control device according to claim 1, wherein
the movement control unit: determines a movement method for moving the robot having a possibility of coming into contact with an object so as not to come into contact with the object; and controls the movement device to move the robot by the movement method.

3. The control device according to claim 2, wherein
the movement control unit determines the movement method based on a position of the robot.

4. The control device according to claim 2, wherein
the movement control unit determines the movement method based on a posture of the robot.

5. The control device according to claim 2, wherein
the movement control unit determines the movement method for moving the robot so as not to come into contact with the object detected by a human sensor.

6. The control device according to claim 2, further comprising:
a light control unit that turns on a light, when the object is detected by a human sensor.

7. The control device according to claim 1, wherein
the movement control unit: determines whether there is a possibility that the robot will come into contact with an object, by using at least one selected from a position and a posture of the robot; and, upon determining that there is the possibility that the robot will come into contact with the object, moves the robot.

8. A control system, comprising:
a control device;
a movement device driven by electrical power supplied from a backup power supply; and
a detection unit that detects an outage of electrical power supplied from a main power supply to a robot, wherein
the control device includes a movement control unit that, when an outage of electrical power is detected by the detection unit, moves the robot by performing control of the movement device that moves the robot, and
the movement device moves the robot based on the control.

9. A non-transitory computer readable medium storing therein a program for causing a processor provided to a control device to
function as a movement control unit that, upon detecting an outage of electrical power supplied from a main power supply to a robot, moves the robot by performing control of a movement device that drives and moves the robot by electrical power supplied from a backup power supply.

10. A control method, comprising:
detecting an outage of electrical power supplied from a main power supply to a robot; and
upon detecting the outage of electrical power, moving the robot by a movement device that is driven by electrical power supplied from a backup power supply.
